(19) United States
(12) Patent Application Publication
(10) Pub. No.: US 2025/0264777 A1
(43) Pub. Date: Aug. 21, 2025

(54) Camera Module with Moving Prism

(71) Applicant: Apple Inc., Cupertino, CA (US)

(72) Inventors: Nicholas D. Smyth, San Jose, CA (US); Patrick A. Carroll, Scotts Valley, CA (US); Yoshikazu Shinohara, Cupertino, CA (US); Paulom Shah, San Jose, CA (US)

(73) Assignee: Apple Inc., Cupertino, CA (US)

(21) Appl. No.: 18/976,143

(22) Filed: Dec. 10, 2024

Related U.S. Application Data
(60) Provisional application No. 63/554,826, filed on Feb. 16, 2024.

(51) Int. Cl. G03B 13/36; G02B 7/18; G03B 30/00; H04N 23/68

(52) U.S. Cl. CPC G03B 13/36; G02B 7/1805; G03B 30/00; H04N 23/687

(57) ABSTRACT

A camera is provided. The camera includes an optical assembly having one or more lenses. The camera also includes an image sensor, a prism, and an actuator. The prism is configured to receive light that has passed through the one or more lenses, reflect the received light multiple times, and transmit the received light to the image sensor in a direction parallel to the optical axis. The image sensor is located at a same side of the prism as the one or more lenses. The actuator is configured to move the prism along an axis parallel to the optical axis for auto focus (AF).

### BACKGROUND

### Priority Claim

This application claims benefit of priority to U.S. Provisional Application Ser. No. 63/554,826, entitled “Camera Module with Moving Prism,” filed Feb. 16, 2024, and which is hereby incorporated herein by reference in its entirety.

### Technical Field

This disclosure relates generally to a camera module and, particularly to a camera module with a moving prism for autofocus (AF).

### Description of the Related Art

The advent of small, mobile multipurpose devices such as smartphones and tablet or pad devices has resulted in a need for high-resolution, small form factor cameras for integration in the devices. Some cameras may incorporate optical image stabilization (OIS) mechanisms that may sense and react to external excitation/disturbance by adjusting location of the optical lens on the X and/or Y axis in an attempt to compensate for unwanted motion of the lens. Furthermore, some cameras may incorporate an autofocus (AF) mechanism whereby the object focal distance can be adjusted to focus an object plane in front of the camera at an image plane to be captured by the image sensor.

### BRIEF DESCRIPTION OF THE DRAWINGS

FIGS. 1A and 1B illustrate components of two example cameras utilizing respective prisms positioned along light paths between respective optical assemblies and respective image sensor assemblies according to at least some embodiments. FIG. 1A shows a cross-sectional view of a first example camera. FIG. 1B shows a cross-sectional view of a second example camera.

FIG. 2 illustrates components of an example camera having a moving prism positioned along a light path between an optical assembly and an image sensor assembly that may, for example, change the focal length of the camera according to at least some embodiments. FIG. 2 shows a perspective view of the exterior of the camera.

FIG. 3 illustrates components of an example camera having a moving prism positioned along a light path between an optical assembly and an image sensor assembly that may, for example, change the focal length of the camera according to at least some embodiments. FIG. 3 shows a cross-sectional view of the camera.

FIG. 4 illustrates an example autofocus (AF) actuator assembly for a camera and including a moving prism positioned along a light path between an optical assembly and an image sensor assembly that may, for example, change the focal length of the camera according to at least some embodiments. FIG. 4 shows a perspective exploded view of the AF actuator assembly.

FIG. 5 illustrates an example optical image stabilization (IOS) actuator assembly for a camera having a moving prism positioned along a light path between an optical assembly and an image sensor assembly that may, for example, change the focal length of the camera according to at least some embodiments. FIG. 5 shows a perspective exploded view of the OIS actuator assembly.

FIG. 6 illustrates an example method of assembling an AF actuator assembly for a camera having a moving prism positioned along a light path between an optical assembly and an image sensor assembly that may, for example, change the focal length of the camera according to at least some embodiments.

FIGS. 7A and 7B illustrates example flexures for a camera having a moving prism positioned along a light path between an optical assembly and an image sensor assembly that may, for example, change the focal length of the camera according to at least some embodiments. FIGS. 7A and 7B show perspective views and cross-sectional views of the respective flexures.

FIGS. 8A and 8B illustrates example flexures for a camera having a moving prism positioned along a light path between an optical assembly and an image sensor assembly that may, for example, change the focal length of the camera according to at least some embodiments. FIGS. 8A and 8B show perspective views and cross-sectional views of the respective flexures.

FIG. 9 illustrates a schematic representation of an example device that may include a camera, in accordance with some embodiments.

FIG. 10 illustrates a schematic block diagram of an example computing device, referred to as computer system, that may include or host embodiments of a camera, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine a based on B.” While in this case, b is a factor that affects the determination of A, such a phrase does not foreclose the determination of a from also being based on C. In other instances, a may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments described herein relate to a camera (e.g., a camera module) having a moving prism positioned between an optical assembly and an image sensor. The camera may include autofocus (AF). For example, the camera may include an AF actuator assembly to move the prism towards (e.g., the +z direction) both the optical assembly and the image sensor to change (e.g., decrease) the focal length of the camera and move away (e.g., the −z direction) from both the optical assembly and the image sensor to change (e.g., increase) the focal length of the camera. The prism (e.g., a trapezoidal prism) may include an odd number of reflection points (e.g., three (3) reflection points) so that light received by the prism from a first direction (e.g., from the optical assembly) is received at a first point (e.g., aligned with the optical assembly) within a plane that is orthogonal to the first direction and is outputted toward the first direction (e.g., towards the image sensor that is adjacent the optical assembly) at a second point (e.g., a different location from the first point, aligned with the image sensor) within the plane that is orthogonal to the first direction. In some aspects, at least one of the optical assembly or the image sensor also moves along the first direction to additionally change the focal length of the camera. In some aspects, the optical assembly and the image does not move along the first direction and thus do not change the focal length of the camera. As such, only movement of the prism along the first direction changes the focal length of the camera. In some aspects, the camera may include optical image stabilization (OIS). For example, the camera may include an OIS actuator assembly to move the image sensor in direction(s) (e.g., the x direction, the y direction) orthogonal to the first direction.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

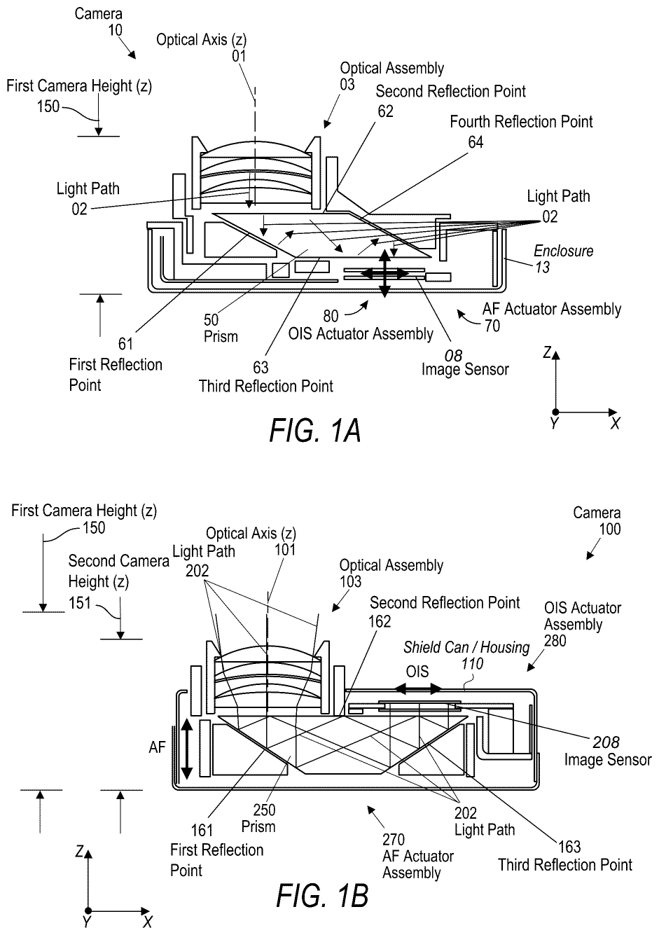

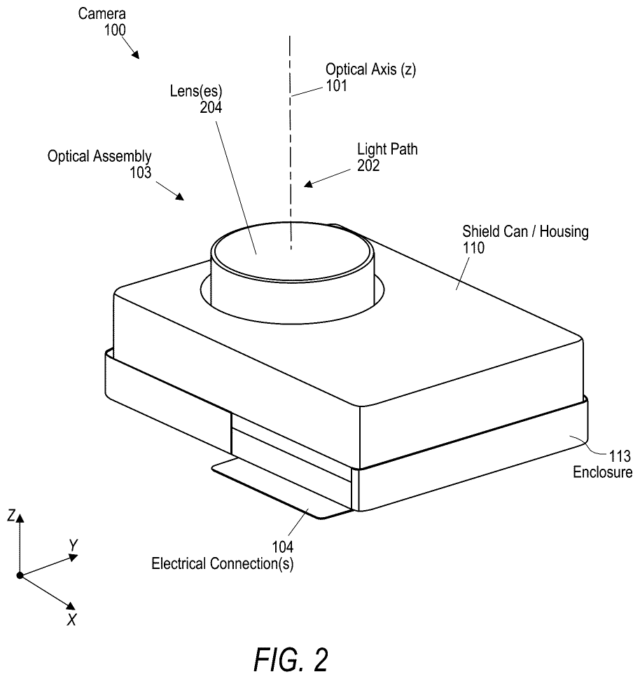

FIGS. 1A and 1B illustrates components of two example cameras utilizing respective prisms positioned along light paths between respective optical assemblies and respective image sensor assemblies according to at least some embodiments. FIG. 1A shows a cross-sectional view of a first example camera 10. FIG. 1B shows a cross-sectional view of a second example camera 100. The camera 10 and the camera 100 of FIG. 1 may include one or more same or similar features as the features described with respect to or illustrated in FIGS. 2, 3, 4, 5, 6, 7A, 7B, 8A, 8B, 9, and 10. The example X-Y-Z coordinate system(s) shown in FIGS. 1A and 1B may be used to discuss aspects of components and/or systems, and may apply to embodiments described throughout this disclosure.

As shown in FIG. 1A, the camera 10 may include an optical assembly 03, a prism 50, and an image sensor 08. The optical assembly 03, the prism 50, and the image sensor 08 may be positioned at different heights (e.g., in the z-direction) relative to each other. For example, the optical assembly 03 may be positioned at a higher position compared to the prism 50, and the image sensor 08. The prism 50 may be positioned at a lower height compared to the optical assembly 03 and a greater (e.g., a higher) height than the image sensor 08. The image sensor 08 may be positioned at a lower position compared to the optical assembly 03, and the prism 50. The prism 50 may receive light along a light path 02 parallel to the optical axis 01 and passing through the optical assembly 03. The prism 50, upon receiving the light, may shift the light (e.g., in the x direction) and output the light in a direction parallel to the optical axis 01, away from the optical assembly 03, and towards the image sensor 08. The prism 50 may shift the light by reflecting the light off an even number of reflection points (e.g., reflection surfaces) before outputting the light towards the image sensor 08.

As shown in FIG. 1A, the prism 50 may shift the light by receiving the light along the light path 02 from the optical assembly 03. The light received by the prism 50 may continue along the light path 02 and may be reflected off the first reflection point 61 (e.g., a first reflection surface) within the prism 50, may continue along the light path 02 and may reflect off the second reflection point 62 (e.g., a second reflection surface) within the prism 50, may continue along the light path 02 and may reflect off the third reflection point 63 (e.g., a third reflection surface) within the prism 50, and may continue along the light path 02 and may reflect off a fourth reflection point 64 (e.g., a fourth reflection surface) within the prism 50 before being outputted by the prism 50 along the light path 02 and in a direction parallel to the optical axis 01, in a direction away from the optical assembly 03, and towards the image sensor 08 for reception by the image sensor 08.

Due to the configuration of the prism 50 (e.g., having an even number of reflection points), the position of the optical assembly 03 may be above (e.g., in the z direction) the prism 50 to enable the prism 50 to receive light from the optical assembly 03 along the light path 02 and the position of the image sensor 08 may be below (e.g., in the z direction) the prism 50 to enable the prism to output the received light along the light path 02 to the image sensor 08. As such moving the prism 50 in the vertical direction (e.g., the z direction) does not change the focal length of the camera 10. Accordingly, in addition to OIS movement of the image sensor 08 (e.g. in the x direction, in the y direction) using the OIS actuator assembly 80, the camera 10 may rely on movement of the image sensor 08 in the z direction using the AF actuator assembly 70 for AF movement to change the focal length of the camera 10.

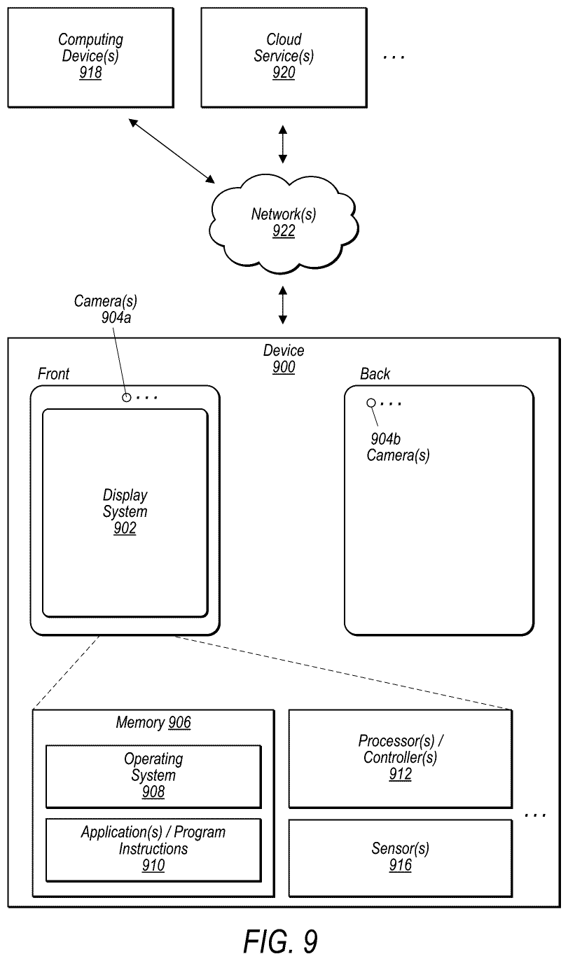

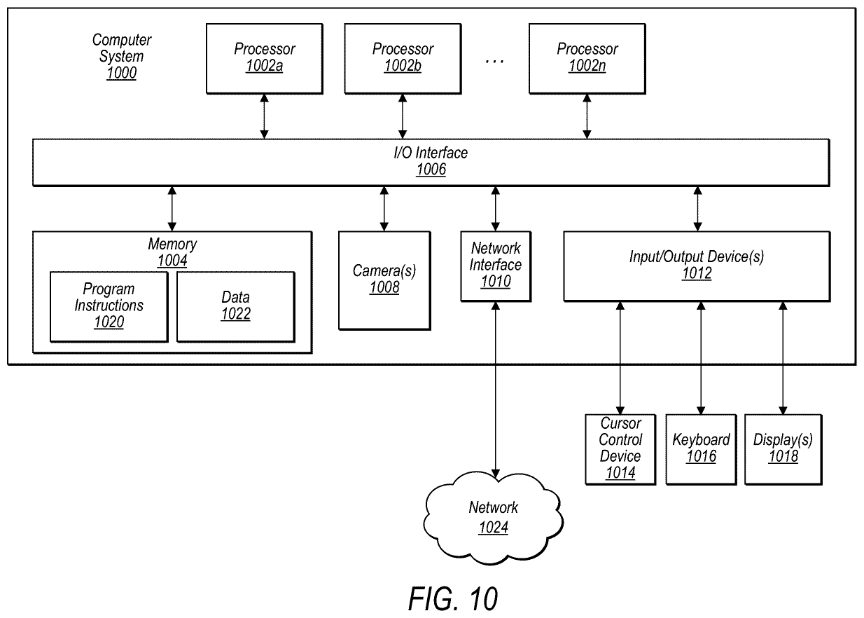

However, the configuration of the camera 10 has several drawbacks. For instance, because the optical assembly 03, the prism 50, and the image sensor 08 are positioned along the z direction in a stacked or off-set but vertically stacked configuration, the height 150 of the camera 10 is at least the sum of the height of the optical assembly 03, the prism 50, and the image sensor 08 (e.g., and associated components of the image sensor 08 including those components for AF and OIS). Also, the space between the image sensor 08 and an enclosure 13 should be great or high enough to accommodate AF movement of the image sensor 08. As described further herein, the additional space or gap allotted between the image sensor 08 and the enclosure 13 (e.g., any outer wall of the camera) to accommodate AF movement of the image sensor 08 may retain a greater amount of heat and thus not dissipate as much heat out of the camera 10 compared to a smaller space or gap that would be used for an image sensor that does not move for AF and instead moves only for OIS. As such, the image sensor 08 may not function as efficiently and/or effectively (e.g., limiting a length 4 k video sessions) due to the greater retention and poorer dissipation of the surrounding heat. Further, the camera 10 may be a component of the handset or mobile communication device (hereafter “handset”) having a display screen. For example, the handset may be the same as or similar to the device 900 illustrated in FIG. 9 or the computer system 1000 illustrated in FIG. 10. As another example, the display screen may be the same as or similar to the display system 902 in FIG. 9 or the display 1018 in FIG. 10. As another example, camera 10 may be the same as or similar to the camera 904b in FIG. 9 or the camera 1008 in FIG. 10. The display screen may be positioned on a surface of the handset opposite the optical assembly 03. Accordingly, due to the stacked configuration of the optical assembly 03, the prism 50, and the image sensor 08, the image sensor 08 may have to dissipate heat through the display screen of the handset. This could further reduce the camera's 10 ability to dissipate heat from the image sensor 08 and/or degrade the functionality and/or the life of the display screen. Also, because the optical assembly 03, the prism 50, and the image sensor 08 are positioned along the z direction in a stacked or off-set but vertically stacked configuration, relying on movement of the prism 50 for AF movement is not possible because moving the prism 50 towards to the optical assembly 03 or towards the image sensor 08 does not increase the length of the light path 02. Additionally, relying on movement of the optical assembly 03 for AF rather than movement of the image sensor 08 further increases the height 150 (e.g., the z direction) of the camera 10. Also, because of the configuration of the optical assembly 03, the prism 50, and the image sensor 08, the change in focal length of the camera 10 may be limited by and/or to the distance that the image sensor 08 is able to move vertically (e.g., in the z direction) for AF.

As shown in FIG. 1B, the camera 100 may include an optical assembly 103, a prism 250, and an image sensor 208. Unlike the optical assembly 03, the prism 50, and the image sensor 08 of the camera 10, both the optical assembly 103 and the image sensor 208 (e.g., and associated components of the image sensor 208 including those components for OIS) may be positioned adjacent each other and at a same height (e.g., a same position along the z direction) as each other. The prism 250 may be positioned below (e.g., along the z direction) both the optical assembly 103 and the image sensor 208. The prism 250 may receive light along a light path 202 parallel to the optical axis 101 and passing through the optical assembly 103. The prism 250, upon receiving the light, may shift the light (e.g., in the x direction) and output the light in a direction parallel to the optical axis 101, in a z direction towards the optical assembly 103, and for reception by the adjacent image sensor 208. The prism 250 may shift the light by reflecting the light off an odd number of reflection points (e.g., reflection surfaces) before outputting the light towards the image sensor 208.

As shown in FIG. 1B, the prism 250 may shift the light by receiving the light along the light path 202 from the optical assembly 103. The light received by the prism 250 may continue along the light path 202 and may be reflected off the first reflection point 161 (e.g., a first reflection surface) within the prism 250, may continue along the light path 202 and may reflect off the second reflection point 162 (e.g., a second reflection surface) within the prism 50, and may continue along the light path 202 and may reflect off a third reflection point 163 (e.g., a third reflection surface) within the prism 250 before being outputted by the prism 250 along the light path 202 and in a direction parallel to the optical axis 101, in the z direction towards the optical assembly 103, and directly towards the image sensor 208 adjacent the optical assembly 103 for reception by the image sensor 208.

Due to the configuration of the prism 250 (e.g., having an odd number of reflection points), the position of the optical assembly 103 may be above (e.g., in the z direction) the prism 250 to enable the prism 250 to receive light from the optical assembly 103 along the light path 202 and the position of the image sensor 208 may be adjacent the optical assembly 103 and above (e.g., in the z direction) the prism 250 to enable the prism 250 to output the received light along the light path 202 to the image sensor 208. As such moving the prism 250 in the vertical direction (e.g., in the z direction) may change the focal length of the camera 100. Accordingly, the camera 100 may rely on movement of the prism 250 in the z direction using the AF actuator assembly 270 for AF movement to change the focal length of the camera 100. The image sensor 208 may still be moved for OIS (e.g., movement in the x direction, movement in the y direction) using the OIS actuator assembly 280.

Compared to the camera 10 and other similar cameras, the configuration of the camera 100 has several advantages. For instance, because the optical assembly 03 and the image sensor 08 are adjacent each other, positioned at a same height (e.g., in the z direction) as each other, and positioned over the prism 250, the height 151 of the camera 100 is less than the height 150 of the camera 10 and is the sum of the height of the optical assembly 03, the prism 50, and a distance between the prism 250 and the enclosure 113 for AF movement of the prism 250 (e.g., and associated components of the prism 250 including those components for AF). Because the image sensor 208 (e.g., and associated components of the image sensor 208 including those component for OIS movement of the image sensor 208) are adjacent the optical assembly 103 and the height of the optical assembly 103 is greater than the height of the image sensor 208 (and associated components), the height 151 of the camera 100 is less than the height 150 of the camera 10 by at least the height of the image sensor 208 and the associated components. Also, the space or gap between the image sensor 208 and the shield can 110 (e.g., any adjacent outer wall of the camera) does not need to accommodate AF movement, because the prism 250, rather than the image sensor 208 moves in the z direction for AF. As such, the space or gap between the shield can 110 and the image sensor 208 is smaller than the space or gap between the enclosure 13 and the image sensor 08 of the camera 10.

As described further herein, the reduced space or gap allotted between the image sensor 208 and the shield can 110 (e.g., any adjacent outer wall of the camera) to accommodate the size and shape of the components associated with and including the image sensor 208 (e.g., and no AF movement of the image sensor 208) may retain a lesser amount of heat compared to the space or gap between the image sensor 08 and the enclosure 13 of the camera 10 and thus dissipate more heat out of the camera 100 compared to the camera 10. As such, the image sensor 208 may function more efficiently and/or effectively (e.g., enabling an increase in length of 4 k video sessions) due to the lesser retention and faster dissipation of the surrounding heat. Further, the camera 100 may be a component of a handset having a display screen. For example, the handset may be the same as or similar to the device 900 illustrated in FIG. 9 or the computer system 1000 illustrated in FIG. 10. As another example, the display screen may be the same as or similar to the display system 902 in FIG. 9 or the display 1018 in FIG. 10. As another example, camera 100 may be the same as or similar to the camera 904b in FIG. 9 or the camera 1008 in FIG. 10. The display screen may be positioned on a surface of the handset opposite the optical assembly 103 and the image sensor 208. Accordingly, due to the positioning of the image sensor 208 adjacent (e.g., the x direction, the y direction), the image sensor 08 may dissipate heat through the surface of the handset opposite the display screen. This could further increase the camera's 100 ability to dissipate heat from the image sensor 208 and/or enhance the functionality and/or the life of the display screen.

Also, because the optical assembly 103 and the image sensor 208 are positioned adjacent each other and higher than or above the prism 250 in the z direction, the prism 250 may be moved using an AF actuator assembly 280 to change the length of the light path 202 (and thus change the focal length of the camera 100). For instance, moving the prism 250 away from both the optical assembly 103 and the image sensor 208 may increase the length of the light path 202 and thus increase the focal length of the camera 100 and moving the prism 250 towards both the optical assembly 103 and the image sensor 208 may decrease the length of the light path 202 and thus decrease the length of the focal length of the camera 100. Also, because of the configuration of the optical assembly 103, the prism 250, and the image sensor 208, the change in focal length of the camera 100 may be greater than the distance that the prism 250 is able to move vertically (e.g., in the z direction) for AF. For instance, because the prism 250 moves for AF towards both the optical assembly 103 and the image sensor 208 to reduce the length of the light path 202 and reduce the focal length of the camera 100, the length of the light path 202 and the focal length of the camera 100 may be reduce by a multiple of two compared to the distance that the prism 250 moves towards both the optical assembly 103 and the image sensor 208. Similarly, because the prism 250 moves for AF away from both the optical assembly 103 and the image sensor 208 to increase the length of the light path 202 and increase the focal length of the camera 100, the length of the light path 202 and the focal length of the camera 100 may be increased by a multiple of two compared to the distance that the prism 250 moves away from both the optical assembly 103 and the image sensor 208. Accordingly, the camera 100 may have a greater focal length (e.g., longer optical zoom) than the focal length of the camera 10. Also, the camera 100 may have a greater AF stroke range (e.g., greater than 1 millimeter (mm)) (e.g., to achieve minimum or shorter focusing distance) compared to the camera 10.

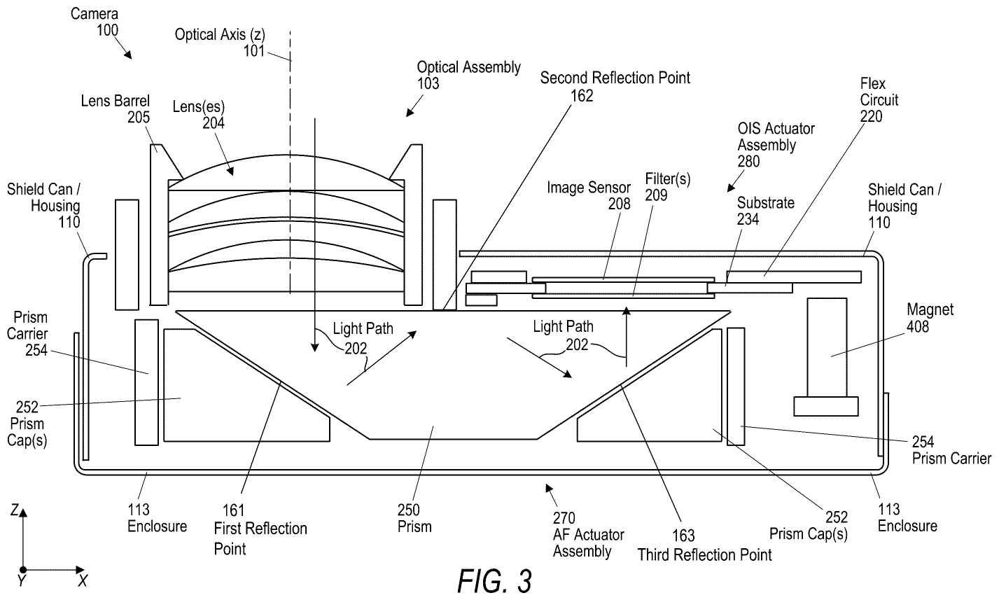

FIGS. 2 and 3 illustrate components of an example camera 100 having a moving prism positioned along a light path between an optical assembly and an image sensor assembly that may, for example, change the focal length of the camera according to at least some embodiments. FIG. 2 shows a perspective view of the exterior of the camera 100. FIG. 3 shows a cross-sectional view of the camera 100. The camera 100 of FIGS. 2 and 3 may include one or more same or similar features as the features described with respect to or illustrated in FIGS. 1A, 1B, 4, 5, 6, 7A, 7B, 8A, 8B, 9, and 10. The example X-Y-Z coordinate system(s) shown in FIGS. 2 and 3 may be used to discuss aspects of components and/or systems, and may apply to embodiments described throughout this disclosure.

In various embodiments, the camera 100 may include an optical assembly 103 having one or more lenses 204 defining an optical axis (z) 101 and a lens barrel 205, a shield can or housing 110, an enclosure or base 113, and electrical connection(s) 104. The shield can 110 may form an outer wall of a top portion (and in some cases side portions) of the camera 100 and form one or more camera shoulders. The enclosure 113 may form an outer wall of a bottom portion (and in some cases side portion(s)) of the camera 100. The electrical connection(s) 104 may extend from the enclosure 113 (and/or the shield can 110) and may electrically connect the camera 100 to an external device. For example, the camera 100 may be the same or similar camera as the camera 904b illustrated in FIG. 9 or the camera 1008 illustrated in FIG. 10. As such, the electrical connection(s) 104 may extend from the enclosure 113 and may electrically connected the camera 100 to the device 900 illustrated in FIG. 9 or the computer system 1000 illustrated in FIG. 10, respectively. In some aspects, the camera 100 may include autofocus (AF) (e.g., movement of the prism 250 in a single direction (e.g., a single dimension, the z direction) (e.g., illustrated in FIG. 3) and/or may include optical image stabilization (OIS) (e.g., movement of the image sensor 208 in one or more directions (e.g., the x direction, the y direction). The optical assembly 103 may be positioned within the frame 302 of the camera 100.

As described herein, the camera 100 may also include an AF actuator assembly 270, the prism 250, prism cap(s) 252, and a prism carrier 254. The prism 250 may move (e.g., via the AF actuator assembly 270) in the z direction for AF. As shown in FIG. 3, both the optical assembly 103 and the image sensor 208 (e.g., and associated components of the image sensor 208 including those components for OIS) may be positioned adjacent each other and at a same height (e.g., a same position along the z direction) as each other. In some aspects, the optical assembly 103 and the image sensor 208 may not move in the z direction for AF. The prism 250 may be positioned below (e.g., along the z direction) both the optical assembly 103 and the image sensor 208. The prism 250 may receive light along a light path 202 parallel to the optical axis 101 and passing through the optical assembly 103. The prism 250, upon receiving the light, may shift the light (e.g., in the x direction) and output the light in a direction parallel to the optical axis 101, in a z direction towards the optical assembly 103, and for reception by the adjacent image sensor 208. The prism 250 may shift the light by reflecting the light off an odd number (e.g., three (3)) of reflection points (e.g., reflection surfaces) before outputting the light towards the image sensor 208. In some aspects, the prism 250 may be a trapezoidal prism, but may additionally or alternatively be any prism that reflects received light off of an odd number of reflection points or reflection surfaces within the prism 250. In some aspects, the prism 250 may be any prism that receives light from a direction at a first point in a plane and outputs the light towards the same direction but at a second point, different from the first point, in the same plane.

For example, the prism 250 may shift the light by receiving the light along the light path 202 from the optical assembly 103. The light received by the prism 250 may continue along the light path 202 and may be reflected off the first reflection point 161 (e.g., a first reflection surface) within the prism 250, may continue along the light path 202 and may reflect off the second reflection point 162 (e.g., a second reflection surface) within the prism 50, and may continue along the light path 202 and may reflect off a third reflection point 163 (e.g., a third reflection surface) within the prism 250 before being outputted by the prism 250 along the light path 202 and in a direction parallel to the optical axis 101, in the z direction towards the optical assembly 103, and directly towards the image sensor 208 adjacent the optical assembly 103 for reception by the image sensor 208. It should be understood that the surface of the second reflection point 162 may be a transmissive surface of the prism 250 that permits light to pass therethrough. However, due to the angle that the first reflection point 160 folds the light path 202 towards the second reflection point 162, the total internal reflectance (TIR) may be great enough so that the transmissive surface may become a reflective surface (an internal reflective surface) at the second reflection point 162 rather than a transmissive surface.

Due to the configuration of the prism 250, the position of the optical assembly 103 may be above (e.g., in the z direction) the prism 250 to enable the prism 250 to receive light from the optical assembly 103 along the light path 202 and the position of the image sensor 08 may be adjacent the optical assembly 103 and above (e.g., in the z direction) the prism 250 to enable the prism 250 to output the received light along the light path 202 to the image sensor 208. As such, moving the prism 250 in the vertical direction (e.g., in the z direction) may change the focal length of the camera 100. Accordingly, the camera 100 may rely on movement of the prism 250 in the z direction using the AF actuator assembly 270 for AF movement to change the focal length of the camera 100. The image sensor 208 may still be moved for OIS (e.g., movement in the x direction, movement in the y direction) using the OIS actuator assembly 280.

As described herein, the AF actuator assembly 270 may move the prism 250 in the z direction to change the focal length of the camera 100. For example, the camera 100 may include the prism 250 retained by a prism carrier 254 and capped at a surface of the prism 250 opposite the optical assembly 103 and the image sensor 208 with prism cap(s) 252. As described further herein, the AF actuator assembly 270 may including a magnet fixedly attached to the prism 250 and/or the prism carrier 254 so that the magnet moves with the prism 250 and a coil positioned adjacent the magnet and fixedly attached to a static portion of the camera 100. The magnet and the coil may together be a voice coil motor (VCM). A magnetic field from the magnet may interact with current flowing through the coil creating Lorentz forces to move the prism 250 towards the optical assembly 103 and the image sensor 208 (e.g., in the +z direction) to decrease the light path 202 and decrease the focal length of the camera 100. Similarly, the magnetic field from the magnet may interact with current flowing through the coil creating Lorentz forces to move the prism 250 away from the optical assembly 103 and the image sensor 208 (e.g., in the −z direction) to increase the light path 202 and increase the focal length of the camera 100. In some aspects, the optical assembly 103 may be static so that it does not move for AF.

In some aspects, the AF actuator assembly 270 may also include one or more sets of ball bearings and one or more tracks formed in the prism carrier 254 and interior surfaces of the frame 302. A pre-load plate positioned opposite the coil from the magnet may pull the prism carrier 254 towards the pre-load plate via the magnet thereby allowing the prism carrier 254 to move vertically using the one or more sets of ball bearings pressed against the one or more respective tracks. In addition, a position sensor located within the coil may be used to determine a position of the prism 250 along the z direction.

In various embodiments, the camera 100 may also include a flex circuit 220, an OIS actuator assembly, a substrate 234 (e.g., an OIS FPC, printed circuit board, and/or the like), the image sensor 208, and filter(s) 209 positioned below (e.g., in the z direction) the image sensor 208. As described herein, the image sensor 208 may be positioned above (e.g., in the z direction) the prism 250 and adjacent (e.g., in the x direction) the optical assembly. The image sensor 208 may be attached to or otherwise integrated into the substrate 234, such that the image sensor 208 is connected to the OIS frame or flex circuit 220 via the substrate 234. For example, a dynamic platform of the flex circuit 220 may retain the substrate 234 for mounting one or more electronic components and/or the image sensor 208. In some aspects, the substrate 234 may include an opening with a cross-section sized to permit light to pass therethrough while also receiving or retaining the filter(s) 209 and the image sensor 208. The substrate 234 may retain the filter(s) 209 and the image sensor 208 around a perimeter of the opening. In some aspects, the image sensor 208 may be retained on the top surface of the substrate 234 while the filter(s) 209 may be positioned between the prism 250 and the image sensor 208. These configuration may allow the substrate 234 to retain the image sensor 208 (and in some cases the filter(s) 209) while also allowing light to pass from the lens(es) 204 of the optics assembly 103, through the prism 250, through the filter(s) 209, and be received by the image sensor 208 for image capturing. In other embodiments, the substrate 234 and the image sensor 208 may be separately attached to the OIS frame or flex circuit 220. For instance, a first set of one or more electrical traces may be routed between the substrate 234 and the OIS frame or flex circuit 220. A second, different set of one or more electrical traces may be routed between the image sensor 208 and the OIS frame or flex circuit 221.

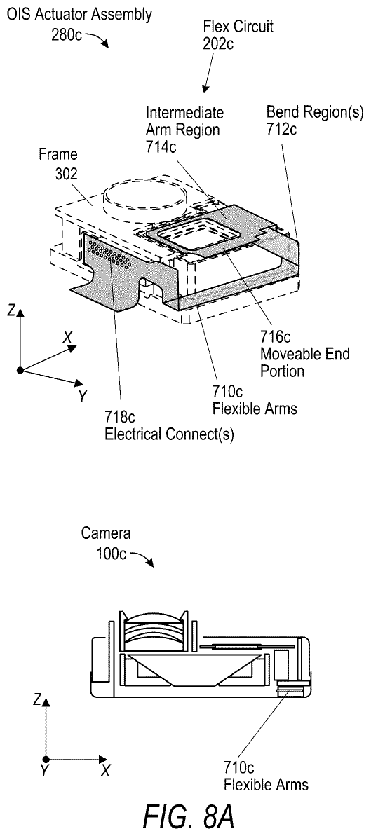

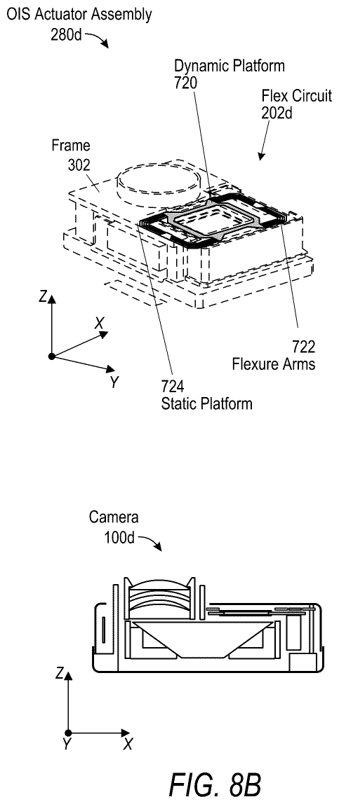

The flexure circuit 220 may have a variety of different configurations. As described further herein at least with respect to FIG. 8B, the flex circuit 220 may include a dynamic platform, a static platform, and a plurality of flexure arms. The flex circuit 220 may be connected to a static portion of the camera (e.g., an interior surface of the shield can 110 and/or the enclosure 113) via a static platform. The flex circuit 220 may also retain the substrate 234, the image sensor 208, and the filter(s) 209 via the dynamic platform. The plurality of flexure arms may provide a flexible mechanical coupling and an electrical coupling between the static platform and the dynamic platform. For example, the flexure arms may allow the dynamic platform to move in one or more directions (e.g., the x direction, the y direction) relative to the static platform (e.g., and a remainder of the camera 100) using components of the OIS actuator assembly 280. The flexure arms (e.g., using one or more electrical traces on each of the flexure arms) may enable electrical signals and power communication between the image sensor 208 and other electrical components of the camera 100. The relatively flat or two-dimensional configuration of the flex circuit having a dynamic platform, a static platform, and a plurality of flexure arms connecting the static platform to the dynamic platform simplifies manufacturing of the camera 100 due to the minimal amount of flexure 220 components that extend in the z direction.

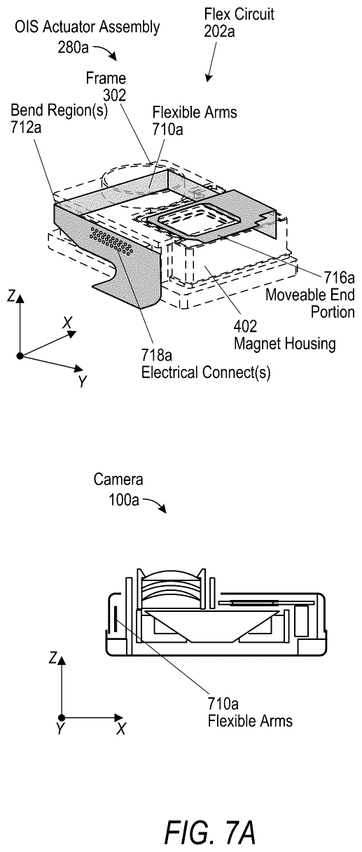

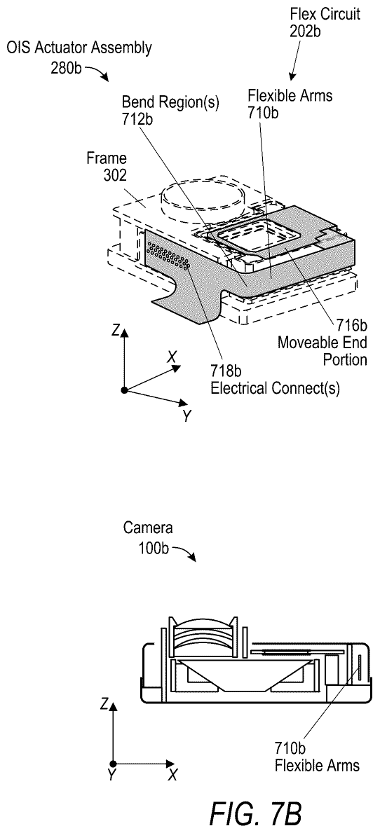

Alternatively, and as described further herein at least with respect to FIGS. 7A, 7B, and 8A, the flex circuit 220 may include various configurations having flexible arms, bend regions between flexible arms, and/or a moveable end portion. The moveable end portion may retain the substrate 234, the image sensor 208, and the filter(s) 209. The flexible arms, bend regions between flexible arms, and/or the moveable end portion may provide a flexible mechanical coupling between the image sensor 208 and a static portion of the camera 100. The flexible arms may permit movement in one or more directions (e.g., the x direction, the y direction) of the moveable end portion via the OIS actuator assembly 280. The bend regions between the flexible arms may enable the flex circuit 220 to wrap around an internal perimeter of the camera 100 (e.g., a perimeter around the camera 100 but within the housing 110). The flexible arms, bend regions between flexible arms, the intermediate arm region, and/or the moveable end portion may enable electrical signal and power communication between the image sensor 208 and a static portion of the camera 100.

As described herein, the OIS actuator assembly 280 may move the image sensor 208 (e.g., including the flex circuit 220, the substrate 234, and the filter(s) 209) for OIS (e.g., in the x direction, in the y direction). The OIS actuator assembly 280 may include at least two magnets and a coil for each of the respective magnets. For example, the OIS actuator assembly 280 may include a first magnet positioned below the flex circuit 220 in a fixed position so that first magnet extends long-ways in the y direction. A first coil may be positioned on the flex circuit 220 over the first magnet (e.g., in the z direction) so that the first coil extends long-ways in the y direction. The first coil may be attached to the flex circuit 22 and may move with movement of the image sensor 208, the substrate 234, and the flex circuit 220. The first magnet and the first coil may together be a voice coil motor (VCM). A magnetic field from the first magnet may interact with current flowing through the first coil creating Lorentz forces to move the image sensor 208, via the flex circuit 220, in the y direction for OIS. Similarly, the OIS actuator assembly 280 may include a second magnet positioned below the flex circuit 220 in a fixed position so that second magnet extends long-ways in the x direction. A second coil may be positioned on the flex circuit 220 over the second magnet (e.g., in the z direction) so that the second coil extends long-ways in the x direction. The second coil may be attached to the flex circuit 220 and may move with movement of the image sensor 208, the substrate 234, and the flex circuit 220. The second magnet and the second coil may together be a voice coil motor (VCM). A magnetic field from the second magnet may interact with current flowing through the second coil creating Lorentz forces to move the image sensor 208, via the flex circuit 220, in the x direction for OIS.

As described further herein, close proximity between magnet groups may cause unwanted magnetic attraction forces. For example, OIS magnets positioned in close proximity to speaker magnets and/or magnets of another camera of an electronic device (e.g., a mobile phone) may cause unwanted magnetic attraction between the OIS magnets and the speaker magnets and/or between the OIS magnets and the magnets of the other camera. In addition, moving magnets (e.g., magnets attached to the substrate 234 and/or the flex circuit 220 rather than magnets fixedly attached to a static portion of the camera 100) may be more susceptible to unwanted magnetic attraction forces between the OIS magnets and other sets of magnets. These unwanted magnetic attraction forces may pull the sets of moving magnets off center or offset reducing their ability or capacity to interact with respective coils to produce Lorentz forces. As such, additional power may be needed to overcome the reduced ability or capacity of the off centered or offset magnets to provide adequate actuation and/or functionality. Conversely, fixed magnets, such as the first magnet and second magnet of the OIS actuator assembly 280 as described herein, are inherently more robust because they are largely undisturbed and/or unaffected by the unwanted magnetic attraction forces. Additionally, fixed magnets, such as the first magnet and second magnet of the OIS actuator assembly 280 as described herein, may allow for more efficient and/or tight packaging of the camera 100 which may enable more space for positioning components within the camera 100 such as larger speakers and/or larger batteries.

In some aspects, the image sensor 208 and the flex circuit 220 may be used for both AF and OIS. For example, AF may be implemented using the prism 250 and the image sensor 208 and flex circuit 220. As another example, AF may be implemented using the optical assembly 103, the prism 250, and the image sensor 208 and flex circuit 220. As such, an AF actuator assembly may be implemented with the image sensor 208, substrate 234, and flex circuit 220 to implement AF movement of the image sensor 208. Further, a space or gap between the image sensor 208 and the shield can 110 (e.g., any adjacent outer wall of the camera) may need to be great (e.g., high or large) enough to accommodate AF movement. However, the large the space or gap is between the image sensor 208 and the shield can 110, the greater the amount of heat is retained within the camera 100 and adjacent the image sensor 208 and the less or the slower the heat is able to dissipate from the camera 100. As such, using the image sensor 208 and the flex circuit 220 for AF in addition to OIS may reduce or degrade the functionality and/or efficiencies of the image sensor 208 (e.g., causing a decrease in length of 4 k video session) due to the greater retention and slower dissipation of heat surrounding the image sensor 208.

In some aspects, the image sensor 208 may only move for OIS and may not move for AF. In this case, as described herein, AF may be implemented by moving the prism 250. Using the image sensor 208 for OIS but not for AF has some advantages over using the image sensor 208 for both OIS and AF. Without AF, a space or gap between the image sensor 208 and the shield can 110 (e.g., any adjacent outer wall of the camera) may be smaller (e.g., shorter, narrower, or lesser) compared to an image sensor that implements AF. With the smaller gap, a lesser amount of heat may be retained within the camera 100 and/or adjacent the image sensor 208 and the more heat from the image sensor 208 and the actuator assemblies (e.g., the OIS actuator assembly 208) may be dissipated from the camera 100 and adjacent the image sensor 208 through the shield can 110. As such, using the image sensor 208 and the flex circuit 220 for only OIS may increase or improve the functionality and/or efficiencies of the image sensor 208 (e.g., enabling an increase in length of 4 k video session) due to the lesser retention and faster dissipation of heat surrounding the image sensor 208.

It should be noted that the camera 100 may be a component of a handset having a display screen. For example, the handset may be the same as or similar to the device 900 illustrated in FIG. 9 or the computer system 1000 illustrated in FIG. 10. As another example, the display screen may be the same as or similar to the display system 902 in FIG. 9 or the display 1018 in FIG. 10. The display screen may be positioned on a surface of the handset opposite the optical assembly 103 and the image sensor 208. Accordingly, due to the positioning of the image sensor 208 adjacent (e.g., the x direction, the y direction), the image sensor 08 may dissipate heat through the surface of the handset opposite the display screen (e.g., the shield can 110 rather than the enclosure 113). This could further increase the camera's 100 ability to dissipate heat from the image sensor 208 and/or enhance the functionality and/or the life of the display screen.

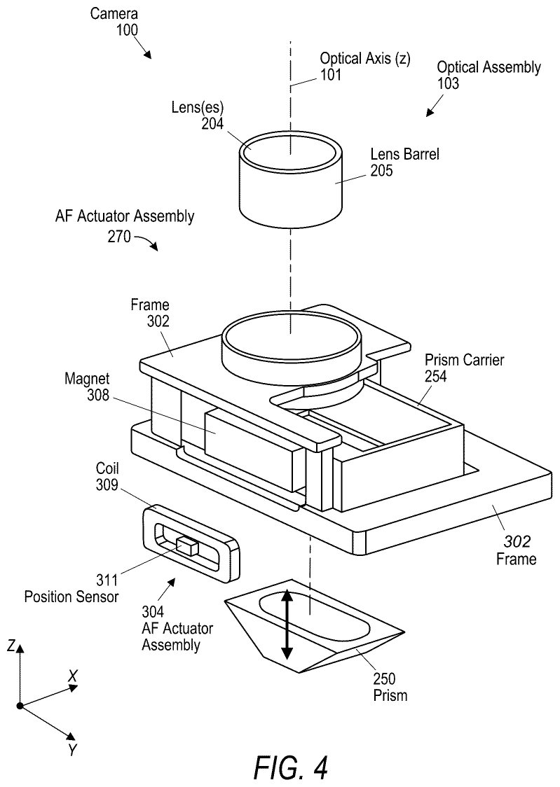

FIG. 4 illustrates an example autofocus (AF) actuator assembly 270 for a camera and including a moving prism positioned along a light path between an optical assembly and an image sensor assembly that may, for example, change the focal length of the camera according to at least some embodiments. FIG. 4 shows a perspective exploded view of the AF actuator assembly 270. The AF actuator assembly 270 of FIG. 4 may include one or more same or similar features as the features described with respect to or illustrated in FIGS. 1A, 1B, 2, 3, 5, 6, 7A, 7B, 8A, 8B, 9, and 10. The example X-Y-Z coordinate system(s) shown in FIG. 4 may be used to discuss aspects of components and/or systems, and may apply to embodiments described throughout this disclosure.

As shown in FIG. 4, the camera 100 may include the prism 250 and a prism carrier 254. The camera 100 may also include a frame 302 retaining the prism carrier 254 and receiving the optical assembly 103 including the lens(es) 204, and the lens barrel 205. The frame 302 may include a space therein not only to receive the prism carrier 254 but also to allow the prism carrier 254 (e.g., retaining the prism 250) move up and down in the z direction for AF. For example, the frame 302 may have a space therein to receive the prism carrier 254 holding the prism 250 and to allow the prism carrier 254 holding the prism 250 to move vertically in the z direction towards and away, via the AF actuator assembly 270, from the lens(es) 204 and the image sensor 208. As such, the frame 302 may allow the prism 250 may move (e.g., via the AF actuator assembly 270) in the z direction for AF.

The frame 302 may also be configured to reside within the shield can 110 and the enclosure 113 and to retain the prism carrier 254 and the prism 250 residing within the prism carrier 254 so that light may be received by the prism 250 from the lens(es) 204 and provided by the prism 250 to the image sensor 208 (not shown) adjacent the lens 204. For example, the prism 250 may be positioned below (e.g., along the z direction) both the optical assembly 103 and the image sensor 208 (not shown). The prism 250 may receive light along a light path parallel to the optical axis 101 and passing through the optical assembly 103. The prism 250, upon receiving the light, may shift the light (e.g., in the x direction) and output the light in a direction parallel to the optical axis 101, in a z direction towards the optical assembly 103, and for reception by the adjacent image sensor 208. The prism 250 may shift the light by reflecting the light off an odd number (e.g., three (3)) of reflection points (e.g., reflection surfaces) before outputting the light towards the image sensor 208. In some aspects, the prism 250 may be a trapezoidal prism, but may additionally or alternatively be any prism that reflects received light off of an odd number of reflection points or reflection surfaces within the prism 250.

The prism 250 may shift the light by receiving the light along the light path 202 from the optical assembly 103. The light received by the prism 250 may continue along the light path and may be reflected off a first reflection point (e.g., a first reflection surface) within the prism 250, may continue along the light path and may reflect off a second reflection point (e.g., a second reflection surface) within the prism 250, and may continue along the light path and may reflect off a third reflection point (e.g., a third reflection surface) within the prism 250 before being outputted by the prism 250 along the light path and in a direction parallel to the optical axis 101, in the z direction towards the optical assembly 103, and directly towards the image sensor 208 adjacent the optical assembly 103 for reception by the image sensor 208.

Due to the configuration of the prism 250 (e.g., having an odd number of reflection points), the position of the optical assembly 103 may be above (e.g., in the z direction) the prism 250 retained by the prism carrier 254 to enable the prism 250 to receive light from the optical assembly 103 along the light path 202 and the position of the image sensor 208 may be adjacent the optical assembly 103 and above (e.g., in the z direction) the prism 250 to enable the prism 250 to output the received light along the light path 202 to the image sensor 208. As such, moving the prism 250 in the vertical direction (e.g., in the z direction) may change the focal length of the camera 100. Accordingly, the camera 100 may rely on movement of the prism 250 in the z direction using the AF actuator assembly 270 for AF movement to change the focal length of the camera 100. The image sensor 208 may still be moved for OIS (e.g., movement in the x direction, movement in the y direction) using the OIS actuator assembly 280.

As described herein, the AF actuator assembly 270 may move the prism 250 in the z direction to change the focal length of the camera 100. For example, the camera 100 may include the prism 250 retained by a prism carrier 254 and capped at a surface of the prism 250 opposite the optical assembly 103 and the image sensor 208 with prism cap(s) 252. The AF actuator assembly 270 may including a magnet 308 fixedly attached to the prism 250 and/or the prism carrier 254 so that the magnet 308 moves with the prism 250 and a coil 309 positioned adjacent the magnet and fixedly attached to a static portion of the camera 100. The magnet 308 and the coil 309 may together be a voice coil motor (VCM). A magnetic field from the magnet 308 may interact with current flowing through the coil 309 creating Lorentz forces to move the prism 250 towards the optical assembly 103 and the image sensor 208 (e.g., in the +z direction) to decrease the light path 202 and decrease the focal length of the camera 100. Similarly, the magnetic field from the magnet 308 may interact with current flowing through the coil 309 creating Lorentz forces to move the prism 250 away from the optical assembly 103 and the image sensor 208 (e.g., in the −z direction) to increase the light path 202 and increase the focal length of the camera 100. In some aspects, the optical assembly 103 may be static so that it does not move for AF. Alternatively, the optical assembly 103 may use another AF actuator assembly for further change in the length of the light path and the focal length of the camera 100.

In some aspects, the AF actuator assembly 270 may also include one or more sets of ball bearings and one or more tracks formed in the prism carrier 254 and interior surfaces of the shield can/housing 110 and/or the enclosure 113. A pre-load plate positioned opposite the coil 309 from the magnet 308 may pull the prism carrier 254 towards the pre-load plate 254 via the magnet 308 thereby allowing the prism carrier 254 to move vertically using the one or more sets of ball bearings pressed against the one or more respective tracks. In addition, a position sensor 311 located within the coil 309 may be used to determine a position of the prism 250 along the z direction.

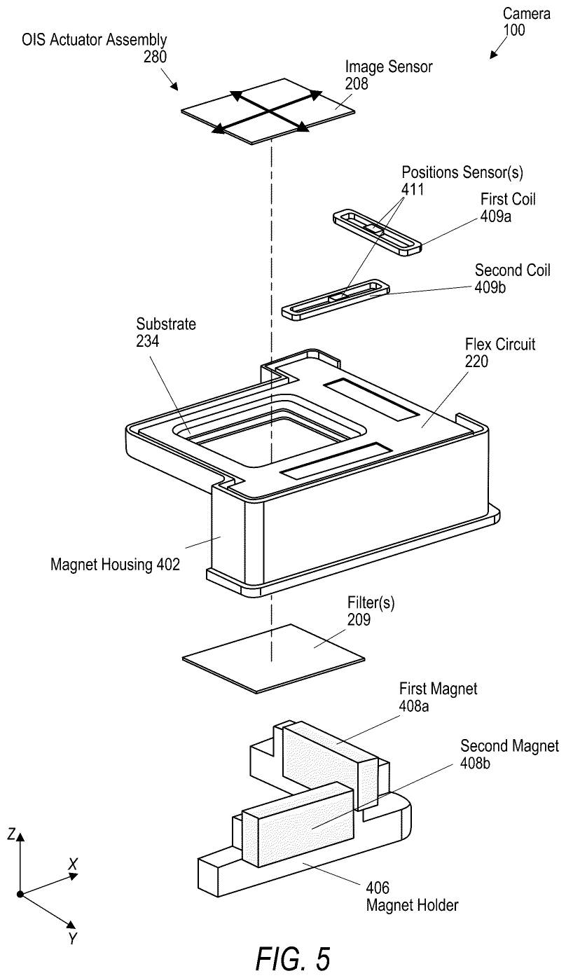

FIG. 5 illustrates an example optical image stabilization (OIS) actuator assembly 280 for the camera 100 having a moving prism 250 positioned along a light path between an optical assembly and an image sensor assembly that may, for example, change the focal length of the camera 100 according to at least some embodiments. FIG. 5 shows a perspective exploded view of the OIS actuator assembly 280. The OIS actuator assembly 280 of FIG. 5 may include one or more same or similar features as the features described with respect to or illustrated in FIGS. 1A, 1B, 2, 3, 4, 6, 7A, 7B, 8A, 8B, 9, and 10. The example X-Y-Z coordinate system(s) shown in FIG. 5 may be used to discuss aspects of components and/or systems, and may apply to embodiments described throughout this disclosure.

As shown in FIG. 5, the camera 100 includes the image sensor 208, the substrate 234, the filter(s) 209, and the OIS actuator assembly 280. The OIS actuator assembly 280 may move the image sensor 208 (e.g., and the flex circuit 220, the substrate 234, and the filter(s) 209) for OIS (e.g., in the x direction, in the y direction). The OIS actuator assembly 280 may include at least two magnets 408 retained by a magnet holder 406 (e.g., a static portion of the camera 100) and a coil 409 for each of the respective magnets. For example, the OIS actuator assembly 280 may include a first magnet 408a positioned below the flex circuit 220 in a fixed position so that first magnet 408a extends long-ways in the y direction. A first coil 409a may be positioned on the flex circuit 220 over the first magnet 408a (e.g., in the z direction) so that the first coil 409a extends long-ways in the y direction. The first coil 409a may be attached to the flex circuit 220 and may move with movement of the image sensor 208, the substrate 234, and the flex circuit 220. The first magnet 408a and the first coil 409a may together be a voice coil motor (VCM). A magnetic field from the first magnet 408a may interact with current flowing through the first coil 409a creating Lorentz forces to move the image sensor 208, via the flex circuit 220 (e.g., retaining the substrate 234) (not shown), in the y direction for OIS. Similarly, the OIS actuator assembly 280 may include a second magnet 408b positioned below the flex circuit 220 in a fixed position so that second magnet 408b extends long-ways in the x direction. A second coil 409b may be positioned on the flex circuit 220 over the second magnet 408b (e.g., in the z direction) so that the second coil 409b extends long-ways in the x direction. The second coil 409b may be attached to the flex circuit 220 and may move with movement of the image sensor 208, the substrate 234, and the flex circuit 220. The second magnet 408b and the second coil 409b may together be a voice coil motor (VCM). A magnetic field from the second magnet 408b may interact with current flowing through the second coil 409b creating Lorentz forces to move the image sensor 208, via the flex circuit 220, in the x direction for OIS. The first magnet 408a and the second magnet 408b may be received and positioned within a magnet housing 402 to securely position the respective magnets below the respect coils. A suspension assembly may be used for movement of the flex circuit 220, the substrate 234, and the image sensor 208. For example, the suspension assembly may use one or more of ball bearings, springs, or suspension wires for movement of the flex circuit 220, the substrate 234, and the image sensor 208.

As described further herein, close proximity between magnet groups may cause unwanted magnetic attraction forces. For example, OIS magnets positioned in close proximity to speaker magnets of an electronic device (e.g., a mobile phone) may cause unwanted magnetic attraction between the OIS magnets and the speaker magnets. In addition, moving magnets (e.g., magnets attached to the substrate 234 and/or the flex circuit 220 rather than magnets fixedly attached to a static portion of the camera 100) may be more susceptible to unwanted magnetic attraction forces between the OIS magnets and other sets of magnets. These unwanted magnetic attraction forces may pull the sets of moving magnets off center or offset reducing their ability or capacity to interact with respective coils to produce Lorentz forces. As such, additional power may be needed to overcome the reduced ability or capacity of the off centered or offset magnets to provide adequate actuation and/or functionality. Conversely, fixed magnets, such as the first magnet 408a and second magnet 408b of the OIS actuator assembly 280 as described herein, are inherently more robust because they are largely undisturbed and/or unaffected by the unwanted magnetic attraction forces. Additionally, fixed magnets, such as the first magnet 408a and second magnet 408b of the OIS actuator assembly 280 as described herein, may allow for more efficient and/or tight packaging of the camera 100 which may enable more space for positioning components within the camera 100 such as larger speakers and/or larger batteries.

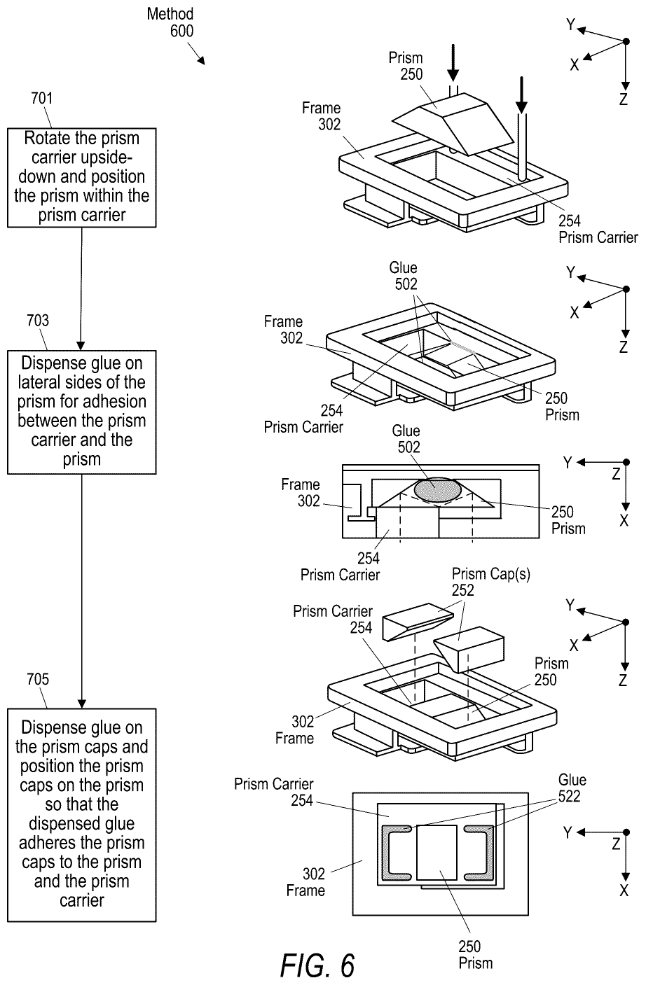

FIG. 6 illustrates an example method 600 of assembling an AF actuator assembly for a camera having a moving prism positioned along a light path between an optical assembly and an image sensor assembly that may, for example, change the focal length of the camera according to at least some embodiments. The method 600 of FIG. 6 may include one or more same or similar features as the features described with respect to or illustrated in FIGS. 1A, 1B, 2, 3, 4, 5, 7A, 7B, 8A, 8B, 9, and 10. The example X-Y-Z coordinate system(s) shown in FIG. 6 may be used to discuss aspects of components and/or systems, and may apply to embodiments described throughout this disclosure.

At step 701, the method 600 may include that a prism carrier 254 may be rotated upside-down and a prism 250 may be positioned within the prism carrier 254. For example, the prism carrier 254 may be positioned within a frame 302 that retains the prism carrier 254 and allow the prism carrier 254 to move in the vertical direction (e.g., the z direction). The frame 302 and the prism carrier 254 may be rotated upside-down so that the prism carrier 254 may receive the prism 250. At step 703, a glue 502 may be dispensed on lateral sides of the prism 250 between the prism 250 and the prism carrier 254 for adhesion between the prism 250 and the prism carrier 254. For example, after the prism 250 is inserted or positioned into the prism carrier 254, glue 502 may be dispensed on a first long side of the prism 250 between the prism 250 and the prism carrier 254. Also, after the prism 250 is inserted or positioned into the prism carrier 254, glue 502 may be dispensed on a second long side of the prism 250 opposite the first long side of the prism 254 between the prism 250 and the prism carrier 254. Applying the glue 502 may securely fix the prism 250 to the prism carrier 254 for reliable AF movement as described herein. At step 705, prism caps 252 may be provided and glue 522 may be dispensed between the prism caps 252 and the prism carrier 254 and on the prism caps 252 so that the prism caps 252 may be securely positioned on surfaces of the prism 250 and so that the prism 250 may be securely fastened to the prism carrier 254. For example, after glue 502 is applied between the prism 250 and the prism carrier 254, glue 522 may be dispensed on the prism caps 252 and the prism caps 252 may be positioned on surfaces of the prism 250. The glue 522 may adhere the prism caps 252 to the prism 250. The glue 522 may also be dispensed between the prism caps 252 and the prism carrier 254 securing both the prism 250 and the prism caps 252 to the prism carrier 254. The prism caps 252 may provide the prism 250 with a more rectangular shape (rather than, for example, a trapezoidal shape of the prism 250 alone) so that the prism 252 may securely fit within the prism carrier 254 for reliable AF movement.

FIGS. 7A, 7B, 8A, and 8B illustrates example flexures for a camera having a moving prism positioned along a light path between an optical assembly and an image sensor assembly that may, for example, change the focal length of the camera according to at least some embodiments. FIGS. 7A, 7B, 8A, and 8B show perspective views and a cross-sectional views of the respective flexures. The example flexures of FIGS. 7A, 7B, 8A, and 8B may include one or more same or similar features as the features described with respect to or illustrated in FIGS. 1A, 1B, 2, 3, 4, 5, 6, 9, and 10. The example X-Y-Z coordinate system(s) shown in FIGS. 7A, 7B, 8A, and 8B may be used to discuss aspects of components and/or systems, and may apply to embodiments described throughout this disclosure.

As shown in FIGS. 7A, 7B, 8A, and 8B, the camera 100 and/or the OIS actuator assembly 280 may also include a flex circuit 220 for retaining the substrate 234, the image sensor 208, and the filter(s) 209 and for permitting (e.g., by flexing) OIS movement of the image sensor 208. The flexure circuit 220 may have a variety of different configurations. For example, as shown in FIG. 7A, a camera 100a may have an OIS actuator assembly 280a that includes a flex circuit 220a having flexible arms 710a, bend regions 712a between flexible arms, a moveable end portion 716a, and/or electrical connections 718a. The moveable end portion 716a may retain the substrate 234, the image sensor 208, and the filter(s) 209 and include an opening therethrough to permit light to reach the image sensor 208 from the prism 250. The electrical connection(s) 718a may connect the flex circuit 220a to the coil 309 of the AF actuator assembly 270 so that one or more drivers connected to the flex circuit 220a may control both AF movement of the prism 250 and OIS movement of the image sensor 208. The flexible arms 710a, bend regions 712a between flexible arms, and/or the moveable end portion 716a may provide a flexible mechanical coupling between the image sensor 208 and a static portion of the camera. The flexible arms 710a may permit movement in one or more directions (e.g., the x direction, the y direction) of the moveable end portion 716a via the OIS actuator assembly 280. The bend regions 712a between the flexible arms 710a may enable the flex circuit 220a to wrap around an internal perimeter and backside of the camera (e.g., a perimeter around the camera but within the housing 110). The flexible arms 710a, bend regions 712a between flexible arms, and/or the moveable end portion 716a may enable electrical signals and power communication between the image sensor 208, the coil 309 via the electrical connection(s) 718a, and a static portion of the camera 100. As shown in FIG. 7A, the configuration of the flex circuit 220a include an extended shield can in the x direction and outward from an optical assembly side of the camera to accommodate the flex circuit 220a wrapped around a backside of the camera.

As another example, as shown in FIG. 7B, a camera 100b may have an OIS actuator assembly 280b that includes a flex circuit 220b having flexible arms 710b, bend regions 712b between flexible arms, a moveable end portion 716b, and/or electrical connections 718b. The moveable end portion 716b may retain the substrate 234, the image sensor 208, and the filter(s) 209 and include an opening therethrough to permit light to reach the image sensor 208 from the prism 250. The electrical connection(s) 718b may connect the flex circuit 220b to the coil 309 of the AF actuator assembly 270 so that one or more drivers connected to the flex circuit 220b may control both AF movement of the prism 250 and OIS movement of the image sensor 208. The flexible arms 710b, bend regions 712b between flexible arms, and/or the moveable end portion 716b may provide a flexible mechanical coupling between the image sensor 208 and a static portion of the camera. The flexible arms 710b may permit movement in one or more directions (e.g., the x direction, the y direction) of the moveable end portion 716b via the OIS actuator assembly 280. The bend regions 712b between the flexible arms 710b may enable the flex circuit 220b to wrap around an internal perimeter and front side of the camera (e.g., a perimeter around the camera 100 but within the housing 110). The flexible arms 710b, bend regions 712b between flexible arms, and/or the moveable end portion 716b may enable electrical signals and power communication between the image sensor 208, the coil 309 via the electrical connection(s) 718b, and a static portion of the camera 100. As shown in FIG. 7B, the configuration of the flex circuit 220b include an extended shield can in the x direction and outward from an image sensor side of the camera to accommodate the flex circuit 220b wrapped around a front side of the camera.

As yet another example, as shown in FIG. 8A, a camera 100c may have an OIS actuator assembly 280c that includes a flex circuit 220c having flexible arms 710c, bend regions 712c between flexible arms, a moveable end portion 716c, and/or electrical connections 718c. The moveable end portion 716c may retain the substrate 234, the image sensor 208, and the filter(s) 209 and include an opening therethrough to permit light to reach the image sensor 208 from the prism 250. The electrical connection(s) 718c may connect the flex circuit 220c to the coil 309 of the AF actuator assembly 270 so that one or more drivers connected to the flex circuit 220c may control both AF movement of the prism 250 and OIS movement of the image sensor 208. The flexible arms 710c, bend regions 712c between flexible arms, and/or the moveable end portion 716c may provide a flexible mechanical coupling between the image sensor 208 and a static portion of the camera. The flexible arms 710c may permit movement in one or more directions (e.g., the x direction, the y direction) of the moveable end portion 716c via the OIS actuator assembly 280. The bend regions 712c between the flexible arms 710c may enable the flex circuit 220c to wrap around an internal perimeter and bottom side of the camera (e.g., a perimeter around the camera but within the housing 110). The flexible arms 710c, bend regions 712c between flexible arms, and/or the moveable end portion 716c may enable electrical signals and power communication between the image sensor 208, the coil 309 via the electrical connection(s) 718c, and a static portion of the camera. As shown in FIG. 8A, the configuration of the flex circuit 220c include an extended shield can in the x direction and outward from an image sensor side of the camera to accommodate the flex circuit 220c wrapped around a bottom side of the camera.

As yet another example, as shown in FIG. 8B, a camera 100d may have an OIS actuator assembly 280d that includes flexure circuit 220d having a dynamic platform 720, a static platform 724, and a plurality of flexure arms 722. The flex circuit 220d may be connected to an interior surface of the shield can 110 and/or the enclosure 113 via a static platform 724. The flex circuit 220d may also retain the substrate 234, the image sensor 208, and the filter(s) 209 via the dynamic platform 720. The plurality of flexure arms 722 may provide a flexible mechanical coupling and an electrical coupling between the static platform 724 and the dynamic platform 720 to allow for electrical power and signal communications between the image sensor 208, the coils 409a and 409b, and the coil 309, and one or more drivers and other electrical components internal and/or external to the camera. For example, the flexure arms 722 may allow the dynamic platform 720 to move in one or more directions (e.g., the x direction, the y direction) relative to the static platform 724 (e.g., and a remainder of the camera) using components of the OIS actuator assembly 280. The flexure arms 722 (e.g., using one or more electrical traces on each of the flexure arms 722) may enable electrical signals and power communication between the image sensor 208, the coils 409a and 409b, and other electrical components of the camera. The relatively flat or two-dimensional configuration of the flex circuit 220d having a dynamic platform 720, a static platform 724, and a plurality of flexure arms 722 connecting the static platform 724 to the dynamic platform 720 simplifies manufacturing of the camera due to the minimal amount of flex circuit 220d components that extend in the z direction.

FIG. 9 illustrates a schematic representation of an example device 1100 that may include a camera (e.g., as described herein with respect FIGS. 1A, 1B, 2, 3, 4, 5, 6, 7A, 7B, 8A, 8B, and 10), in accordance with some embodiments. In some embodiments, the device 900 may be a mobile device and/or a multifunction device. In various embodiments, the device 900 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 900 may include a display system 902 (e.g., comprising a display and/or a touch-sensitive surface) and/or one or more cameras 904. In some non-limiting embodiments, the display system 902 and/or one or more front-facing cameras 904a may be provided at a front side of the device 900, e.g., as indicated in FIG. 9. Additionally, or alternatively, one or more rear-facing cameras 904b may be provided at a rear side of the device 900. In some embodiments comprising multiple cameras 904, some or all of the cameras may be the same as, or similar to, each other. Additionally, or alternatively, some or all of the cameras may be different from each other. In various embodiments, the location(s) and/or arrangement(s) of the camera(s) 904 may be different than those indicated in FIG. 9.

Among other things, the device 900 may include memory 906 (e.g., comprising an operating system 908 and/or application(s)/program instructions 910), one or more processors and/or controllers 912 (e.g., comprising CPU(s), memory controller(s), display controller(s), and/or camera controller(s), etc.), and/or one or more sensors 916 (e.g., orientation sensor(s), proximity sensor(s), and/or position sensor(s), etc.). In some embodiments, the device 900 may communicate with one or more other devices and/or services, such as computing device(s) 918, cloud service(s) 920, etc., via one or more networks 922. For example, the device 900 may include a network interface (e.g., network interface 910) that enables the device 900 to transmit data to, and receive data from, the network(s) 922. Additionally, or alternatively, the device 900 may be capable of communicating with other devices via wireless communication using any of a variety of communications standards, protocols, and/or technologies.

FIG. 10 illustrates a schematic block diagram of an example computing device, referred to as computer system 1000, that may include or host embodiments of a camera (e.g., as described herein with respect to FIGS. 1A, 1B, 2, 3, 4, 5, 6, 7A, 7B, 8A, 8B, and 9). In addition, computer system 1000 may implement methods for controlling operations of the camera and/or for performing image processing images captured with the camera. In some embodiments, the device 1000 (described herein with reference to FIG. 10) may additionally, or alternatively, include some or all of the functional components of the computer system 1000 described herein.

The computer system 1000 may be configured to execute any or all of the embodiments described above. In different embodiments, computer system 1000 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1000 includes one or more processors 1002 coupled to a system memory 1004 via an input/output (I/O) interface 1006. Computer system 1000 further includes one or more cameras 1008 coupled to the I/O interface 1006. Computer system 1000 further includes a network interface 1010 coupled to I/O interface 1006, and one or more input/output devices 1012, such as cursor control device 1014, keyboard 1016, and display(s) 1018. In some cases, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1002, or a multiprocessor system including several processors 1002 (e.g., two, four, eight, or another suitable number). Processors 1002 may be any suitable processor capable of executing instructions. For example, in various embodiments processors 1002 may be general-purpose or embedded processors implementing any of a variety of instruction set architectures (ISAs), such as the x86, PowerPC, SPARC, or MIPS ISAs, or any other suitable ISA. In multiprocessor systems, each of processors 1002 may commonly, but not necessarily, implement the same ISA.

System memory 1004 may be configured to store program instructions 1020 accessible by processor 1002. In various embodiments, system memory 1004 may be implemented using any suitable memory technology, such as static random access memory (SRAM), synchronous dynamic RAM (SDRAM), nonvolatile/Flash-type memory, or any other type of memory. Additionally, existing camera control data 1022 of memory 1004 may include any of the information or data structures described above. In some embodiments, program instructions 1020 and/or data 1022 may be received, sent or stored upon different types of computer-accessible media or on similar media separate from system memory 1004 or computer system 1000. In various embodiments, some or all of the functionality described herein may be implemented via such a computer system 1000.

In one embodiment, I/O interface 1006 may be configured to coordinate I/O traffic between processor 1002, system memory 1004, and any peripheral devices in the device, including network interface 1010 or other peripheral interfaces, such as input/output devices 1012. In some embodiments, I/O interface 1006 may perform any necessary protocol, timing or other data transformations to convert data signals from one component (e.g., system memory 1004) into a format suitable for use by another component (e.g., processor 1002). In some embodiments, I/O interface 1006 may include support for devices attached through various types of peripheral buses, such as a variant of the Peripheral Component Interconnect (PCI) bus standard or the Universal Serial Bus (USB) standard, for example. In some embodiments, the function of I/O interface 1006 may be split into two or more separate components, such as a north bridge and a south bridge, for example. Also, in some embodiments some or all of the functionality of I/O interface 1006, such as an interface to system memory 1004, may be incorporated directly into processor 1002.

Network interface 1010 may be configured to allow data to be exchanged between computer system 1000 and other devices attached to a network 1024 (e.g., carrier or agent devices) or between nodes of computer system 1000. Network 1024 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1010 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1012 may, in some embodiments, include one or more display terminals, keyboards, keypads, touchpads, scanning devices, voice or optical recognition devices, or any other devices suitable for entering or accessing data by one or more computer systems 1000. Multiple input/output devices 1012 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1010.

Those skilled in the art will appreciate that computer system 1000 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an optical assembly comprising one or more lenses defining an optical axis;
an image sensor;
a prism configured to receive light that has passed through the one or more lenses, reflect the received light multiple times, and transmit the received light to the image sensor in a direction parallel to the optical axis, wherein the image sensor is located at a same side of the prism as the one or more lenses; and
an actuator configured to move the prism along an axis parallel to the optical axis for auto focus (AF).

2. The camera of claim 1, wherein the actuator is configured to move the prism along the axis parallel to the optical axis for AF to change a distance between the prism and both the optical assembly and the image sensor so as to change a focal length of the camera by a factor of two relative to the distance in the one dimension by which the prism moves.

3. The camera of claim 1, wherein the light received by the prism is reflected within the prism an odd number times.

4. The camera of claim 1, wherein the actuator is configured to move the prism along the axis parallel to the optical axis for AF a distance away from both the image sensor and the optical assembly to increase the focal length of the camera.

5. The camera of claim 1, wherein the actuator is configured to move the prism along the axis parallel to the optical axis for AF a distance towards both the image sensor and the optical assembly to decrease the focal length of the camera.

6. The camera of claim 1, wherein the actuator comprises a voice coil motor (VCM) actuator having a magnet that moves with the prism and a coil attached to a component of the camera that does not move with movement of the prism.

7. The camera of claim 1, wherein the actuator is a first actuator, the camera further comprising a second actuator and a flex circuit retaining the image sensor, and wherein the second actuator is configured to move the image sensor and the flex circuit along two different axes that are both orthogonal to the optical axis.

8. The camera of claim 7, wherein the second actuator comprises:
a first coil that moves with movement of the image sensor and the flex circuit along a first axis of the two different axes;
a first magnet attached to a component of the camera that does not move with movement of the image sensor and flex circuit along the first axis of the two different axes;
a second coil that moves with movement of the image sensor and flex circuit along a second axis of the two different axes; and
a second magnet attached to a component of the camera that does not move with movement of the image sensor and flex circuit along the second axis of the two different axes.

9. An actuator assembly for a camera, comprising:
an autofocus (AF) actuator module comprising:
a prism configured to receive light through a surface, reflect the light multiple times within the prism, and output the light through the surface and towards an image sensor, and
an actuator configured to move the prism along an axis orthogonal to the surface of the prism for auto focus (AF); and
wherein the AF actuator module is configured to couple with an optical image stabilization (OIS) actuator module that is configured to move the image sensor for OIS.

10. The actuator assembly of claim 9, further comprising:
the OIS actuator module comprising the image sensor and a flex circuit, wherein the OIS actuator module is configured to move the image sensor in one or more directions orthogonal to the axis for OIS.

11. The actuator assembly of claim 9, wherein the light received by the prism is reflected within the prism an odd number times.

12. The actuator assembly of claim 9, wherein the prism comprises a trapezoidal prism.

13. The actuator assembly of claim 9, wherein the AF actuator module comprises a voice coil motor (VCM) actuator having a magnet that moves with the prism and a coil that is stationary with respect to the magnet and the prism.

14. A device, comprising:
a display;
a camera;
one or more processors; and
memory storing program instructions executable by the one or more processors to cause images captured by the camera to be displayed on the display; and
the camera comprising:
an optical assembly having one or more lenses,
an image sensor,
a prism configured to receive light that has passed through the one or more lenses, reflect the received light multiple times, and transmit the received light to the image sensor in a direction parallel to the optical axis, wherein the image sensor is located at a same side of the prism as the one or more lenses, and
an actuator configured to move the prism along an axis parallel to the optical axis for auto focus (AF).

15. The device of claim 14, wherein the actuator is configured to move the prism along the axis parallel to the optical axis for AF to change a distance between the prism and both the optical assembly and the image sensor so as to change a focal length of the camera by a factor of two relative to the distance in the one dimension by which the prism moves.

16. The device of claim 14, wherein the light received by the prism is reflected within the prism an odd number times.

17. The device of claim 14, wherein the actuator is configured to move the prism along the axis parallel to the optical axis for AF a distance away from both the image sensor and the optical assembly to increase the focal length of the camera.

18. The device of claim 14, wherein the actuator is configured to move the prism along the axis parallel to the optical axis for AF a distance towards both the image sensor and the optical assembly to decrease the focal length of the camera.

19. The device of claim 14, wherein the actuator comprises a voice coil motor (VCM) actuator having a magnet that moves with the prism and a coil attached to a component of the camera that does not move with movement of the prism.

20. The device of claim 14, wherein the optical assembly is positioned on a wall of a housing of the device that is opposite the display, and wherein the image sensor is positioned adjacent the optical assembly and adjacent the wall to dissipate heat from the image sensor through the wall.
